(19) United States
(12) Patent Application Publication
(10) Pub. No.: US 2013/0141206 A1
(43) Pub. Date: Jun. 6, 2013

(54) COMMON MODE NOISE FILTER

(71) Applicant: SAMSUNG ELECTRO-MECHANICS CO., LTD., Suwon-si (KR)

(72) Inventors: Sang Moon LEE, Seoul (KR); Sung Kwon WI, Seoul (KR); Yong Suk KIM, Yongin-si (KR); Ju Hwan YANG, Suwon-si (KR); Won Chul SIM, Seongnam-si (KR); Jeong Bok KWAK, Suwon-si (KR); Jeong Min CHO, Seongnam-si (KR); Young Seuck YOO, Seoul (KR)

(73) Assignee: SAMSUNG ELECTRO-MECHANICS CO., LTD., Suwon-si (KR)

(21) Appl. No.: 13/707,327

(22) Filed: Dec. 6, 2012

(30) Foreign Application Priority Data
Dec. 6, 2011 (KR) 10-2011-0129844

(51) Int. Cl. H01F 17/00

(52) U.S. Cl. CPC H01F 17/0006
USPC 336/200

(57) ABSTRACT

Disclosed herein is a common mode noise filter including: a plurality of insulation layers configuring a laminated body formed on a substrate; internal electrode coils included in the plurality of insulation layers; external electrode terminals connected to an end portion of the internal electrode coils; and a magnetic layer formed on a surface of the laminated body. According to the present invention, the common mode noise filter has the magnetic layer including the conductive metal on the uppermost layer thereof, such that the permeability of the ferrite composite may be increased and the ferrite powder may be effectively compensated for the eddy current loss of the internal electrode coil, thereby making it possible to improve the impedance characteristics of the common mode noise filter.

### CROSS REFERENCE(S) TO RELATED APPLICATIONS

This application claims the benefit under 35 U.S.C. Section 119 of Korean Patent Application Serial No. 10-2011-0129844, entitled “Common Mode Noise Filter” filed on Dec. 6, 2011, which is hereby incorporated by reference in its entirety into this application.

### BACKGROUND OF THE INVENTION

1. Technical Field

The present invention relates to a common mode noise filter.

2. Description of the Related Art

Electronic devices around us generate more or less radiation noise. Since noise freely and suddenly changes, noise immunity allowing an electronic device itself not to generate noise and preventing an electronic device from malfunctioning caused by external noise has been required. This is the basis of electromagnetic compatibility (EMC).

Generally, conduction noise may be ‘bypassed’ to a ground by a condenser, or ‘be absorbed’ by a resistor and a ferrite core, a chip bead, or the like, to thereby be converted into heat and then removed.

As a measure against conduction noise, there is another important method. That is a method of ‘reflecting’ noise current using a property of an inductor. The inductor allows a direct current to easily flow, but allows an alternate current not to easily flow due to increased impedance (resistance for the alternate current). However, as a transferring type of conduction noise, there are two types: a differential mode type and a common mode type. Therefore, a measure against noise according to a type of noise is required. If the type of the noise is not confirmed, even though a noise suppression component is added to a circuit, the noise may further increase.

The common mode is a conduction mode in which the noise transfers in the same direction with respect to an outward path and a return path. The common mode noise may be generated by impedance unbalance of a wiring system. In addition, the higher a frequency is, the more significant the common mode noise occurs. In addition, since the common mode noise is also transferred to the ground, or the like, to return while drawing a large loop, various noise disturbances may be generated even in a distant electronic device.

Therefore, in a digital device, a measure against the common mode noise is regarded as important as or more important than a measure against the differential mode noise.

A common mode noise filter 10 has a structure in which a ferrite substrate 11 is installed with an insulation layer 13 having internal coil conductors 12 formed therein, wherein the internal coil conductors 12 are connected to via electrodes (not shown), and then the substrate 11 is connected to external terminal electrodes 14 at an outer peripheral surface thereof, as shown in FIG. 1. In addition, an inner portion of the coil conductor 12 is provided with an opening part 15 penetrating through the insulation layer 13, and the opening part 15 includes a magnetic layer 16 filled with a magnetic material and formed therein.

A structure of FIG. 1 viewed from above is shown in FIG. 2.

### SUMMARY OF THE INVENTION

An object of the present invention is to provide a thin film type common mode noise filter capable of having improved impedance characteristics, a high precision fine line width, and a thick thickness by increasing permeability in order to solve problems of a winding type or a laminated type common mode noise filter of the related art.

According to a first exemplary embodiment of the present invention, there is provided a common mode noise filter including: a plurality of insulation layers configuring a laminated body formed on a substrate; internal electrode coils included in the plurality of insulation layers; external electrode terminals connected to an end portion of the internal electrode coils; and a magnetic layer formed on a surface of the laminated body.

The magnetic layer may include a ferrite powder, a polymer binder, and a conductive metal.

The ferrite powder may be at least one kind selected from a group consisting of Fe₂O₃, NiO, CuO, ZnO, MnO, Co₃O₄, Bi₂O₃, and Ti.

The polymer binder may be at least one kind selected from a group consisting of an epoxy resin, a polyimide resin, a polyamide resin, and a polyaniline resin.

The conductive metal may be at least one kind selected from a group consisting of Fe, FeNi, FeCo, FeAl, FeSiAl, and an alloy thereof.

The conductive metal may have a permeability of 1,000 to 200,000.

The ferrite powder and the conductive metal may be mixed at a weight ratio of 3:7 to 7:3.

The ferrite powder and the polymer binder may be mixed at a weight ratio of 7:1 to 10:1.

### BRIEF DESCRIPTION OF THE DRAWINGS

FIGS. 1 and 2 show a structure of a common mode noise filter according to the related art;

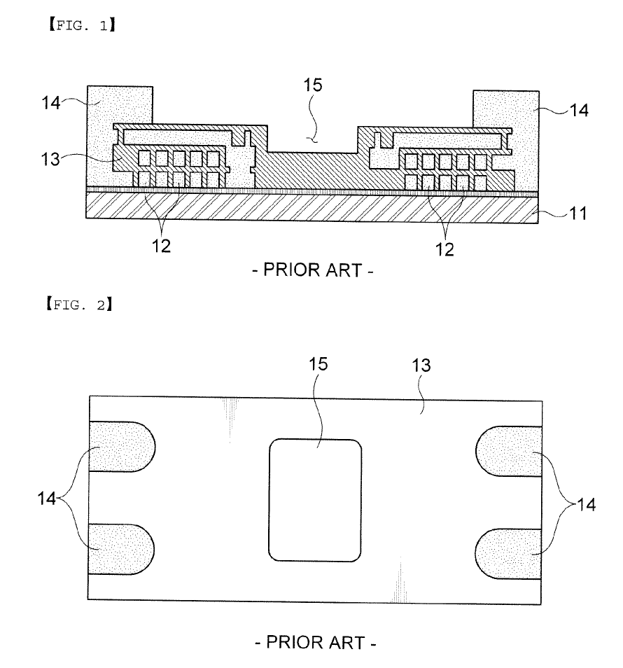

FIGS. 3 and 4 show a structure of a common mode noise filter according to an exemplary embodiment of the present invention; and

FIG. 5 shows a process of manufacturing the common mode noise filter according to the exemplary embodiment of the present invention.

### DESCRIPTION OF THE PREFERRED EMBODIMENTS

Hereinafter, the present invention will be described in more detail with respect to the accompanying drawings.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

The present invention relates to a thin-film type common mode noise filter, which has a fine line width, excellent connectivity between upper and lower patterns to easily form an internal circuit pattern, and excellent connectivity with an external electrode, thereby making it possible to have excellent electrical characteristics and reliability.

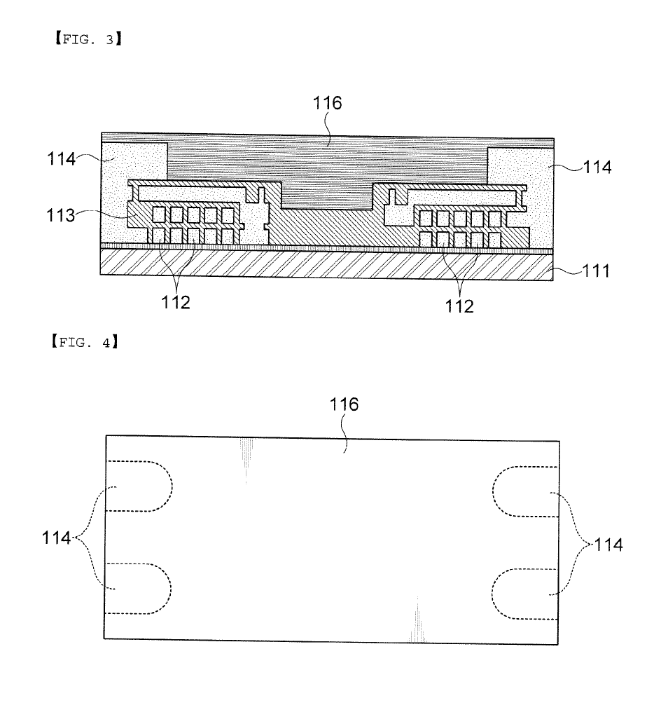

FIG. 3 shows a structure of a common mode noise filter 100 according to an exemplary embodiment of the present invention. Referring to FIG. 3, the common mode noise filter includes a plurality of insulation layers 113 configuring a laminated body formed on a substrate 111; internal electrode coils 112 included in the plurality of insulation layers 113; external electrode terminals 114 connected to an end portion of the internal electrode coils 112; and a magnetic layer 116 formed on a surface of the laminated body.

As the substrate 111 used in the common mode noise filter according to the exemplary embodiment of the present invention, a general ferrite substrate may be used, and a material of the ferrite is not particularly limited.

The plurality of insulation layers 113 are laminated on the ferrite substrate 111 to form the laminated body, and each of the insulation layers 113 includes the internal electrode coils 112 formed therein. The internal electrode coils 112 of each of the insulation layers 113 are connected to each other by via electrodes adjacent thereto (not shown).

The insulation layer 113 serves to insulate the internal electrode coils 112 from each other and to planarize a surface in which the internal electrode coils 112 are formed.

As a material of the insulation layer 113, a polymer resin having excellent electrical or magnetic insulation characteristics and excellent formability, for example, an epoxy resin, a polyimide resin, or the like, may be used, but the present invention is not particularly limited thereto.

Further, the internal electrode coil 112 formed in each of the insulation layers 113 may be made of copper (Cu), aluminum (Al), or the like, having excellent conductivity and formability and be formed by using an etching method using photolithography, an additive method (a plating method), or the like. However, the method of forming the internal electrode coil is not particularly limited thereto.

The opening part penetrating through each of the insulation layers 113 is formed at a central portion of the insulation layer 113, that is, inner portions of each of the internal electrode coils 112. The internal electrode coils 112 formed in each of the insulation layers 113 are electrically connected to each other by the via electrodes of each of the insulation layers.

In addition, each end portion of the internal electrode coils 112 is connected to the external electrode terminals 114, and four external electrode terminals 114 are formed at both sides of an outer peripheral surface of the laminated body. FIG. 3 viewed from above is shown in FIG. 4.

The present invention has a structure having a magnetic layer 116 formed on a surface of the laminated body. In general, the magnetic layer is configured of a ferrite composite formed by mixing ferrite and a polymer binder. In order to improve a permeability value, a method of increasing a particle size of the ferrite, a method of decreasing an amount of polymer binder, or a method of raising a temperature at the time of molding, or the like, is used. However, when the particle size is increased, high frequency characteristics are deteriorated, and when the amount of polymer binder is decreased, insulation and withstanding voltage characteristics of a green compact may be deteriorated. Further, the method of raising a temperature may cause deterioration of workability, a high cost of the equipment, and a problem in reliability of a filter.

Therefore, in the present invention, the magnetic layer includes a conductive metal having excellent permeability together with a ferrite powder and a polymer binder to improve the permeability of the common mode noise filter, thereby making it possible to improve the impedance characteristics.

The ferrite powder configuring the magnetic layer of the present invention may be at least one kind selected from a group consisting of Fe₂O₃, NiO, CuO, ZnO, MnO, Co₃O₄, Bi₂O₃, and Ti; however, the present invention is not limited thereto. It is preferable in view of an increase of permeability that the ferrite powder has a particle size of 10 to 100 μm.

In addition, the polymer binder configuring the magnetic layer is at least one kind selected from a group consisting of an epoxy resin, a polyimide resin, a polyamide resin, and a polyaniline resin. The polymer binder having excellent heat stability may be preferably used.

Further, the conductive metal configuring the magnetic layer may be at least one kind selected from a group consisting of Fe, FeNi, FeCo, FeAl, FeSiAl, and alloy thereof. The conductive metal has permeability 4 to 10 times larger than that of the ferrite powder. The conductive metal is included to increase the permeability, and improve impedance characteristics of the common mode noise filter.

The conductive metal according to the exemplary embodiment of the present invention has permeability of 1,000˜200,000, which is advantageous for improving the impedance characteristics of the noise filter.

In the magnetic layer according to the embodiment of the present invention, it is preferable in view of the dispersibility and insulation characteristics that the ferrite power and the conductive metal are mixed at a weight ratio of 3:7 to 7:3.

In the magnetic layer, it is preferable in view of dispersibility and process capability that the ferrite power and the polymer binder are mixed at a weight ratio of 7:1 to 10:1.

In addition, the magnetic layer according to the present invention may include a general additive, such as a dispersant.

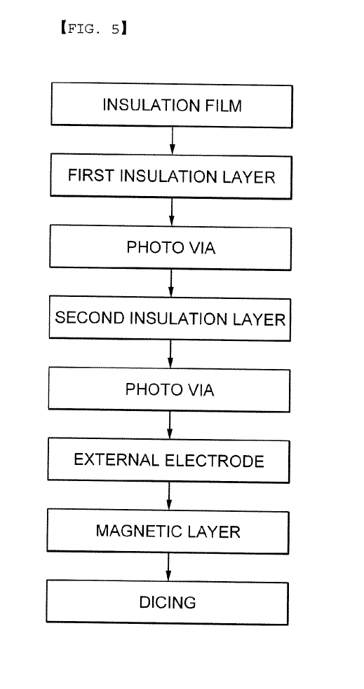

FIG. 5 shows a process of manufacturing the common mode noise filter according to the exemplary embodiment of the present invention. Referring to FIG. 5, a first insulation layer is formed on an insulation film which is formed of ferrite substrate, internal electrode coils are formed in the first insulation layer and a second insulation layer, and the internal electrode coils formed in each of the insulation layers are electrically connected to each other through via electrodes. An outer peripheral end of the internal electrode coil is connected to the external electrode terminal through an outlet terminal.

Next, internal electrode coils of the second insulation layer and a third insulation layer are electrically connected to each other through via electrodes, and the internal electrode coils formed in each of the insulation layers are connected to the external electrode terminals. In addition, a magnetic layer is formed on the outermost insulation layer, and a final common mode noise filter may be manufactured by a dicing process.

The magnetic layer according to the present invention may be configured to include the ferrite powder, the polymer binder, and the conductive metal.

It is preferable in view of a wetting property and a defoaming property that the magnetic layer according to the exemplary embodiment of the present invention has a thickness of 50 to 100 μm.

In the present invention, the magnetic layer of the common mode noise filter may include a ferrite powder, a polymer binder, and a conductive metal having excellent permeability to improve the impedance characteristics.

According to the present invention, the common mode noise filter has the magnetic layer including the conductive metal on the uppermost layer thereof, such that the permeability of the ferrite composite may be increased and the ferrite powder may be effectively compensated for the eddy current loss of the internal electrode coil, thereby making it possible to improve the impedance characteristics of the common mode noise filter.

Therefore, according to the present invention, the thin film type common mode noise filter having the high precision fine line width and the thick thickness may be provided.

While the present invention has been shown and described in connection with the embodiments, it will be apparent to those skilled in the art that modifications and variations can be made without departing from the spirit and scope of the invention as defined by the appended claims.

What is claimed is:

1. A common mode noise filter comprising:
a plurality of insulation layers configuring a laminated body formed on a substrate;
internal electrode coils included in the plurality of insulation layers;
external electrode terminals connected to an end portion of the internal electrode coils; and
a magnetic layer formed on a surface of the laminated body.

2. The common mode noise filter according to claim 1, wherein the magnetic layer includes a ferrite powder, a polymer binder, and a conductive metal.

3. The common mode noise filter according to claim 2, wherein the ferrite powder is at least one kind selected from a group consisting of Fe₂O₃, NiO, CuO, ZnO, MnO, Co₃O₄, Bi₂O₃, and Ti.

4. The common mode noise filter according to claim 2, wherein the polymer binder is at least one kind selected from a group consisting of an epoxy resin, a polyimide resin, a polyamide resin, and a polyaniline resin.

5. The common mode noise filter according to claim 2, wherein the conductive metal is at least one kind selected from a group consisting of Fe, FeNi, FeCo, FeAl, FeSiAl, and an alloy thereof.

6. The common mode noise filter according to claim 2, wherein the conductive metal has a permeability of 1,000 to 200,000.

7. The common mode noise filter according to claim 2, wherein the ferrite powder and the conductive metal are mixed at a weight ratio of 3:7 to 7:3.

8. The common mode noise filter according to claim 2, wherein the ferrite powder and the polymer binder are mixed at a weight ratio of 7:1 to 10:1.
